(19) United States
(12) Patent Application Publication
(10) Pub. No.: US 2011/0148842 A1
(43) Pub. Date: Jun. 23, 2011

(54) SOURCE DRIVER FOR LIQUID CRYSTAL DISPLAY PANEL

(75) Inventor: Akira Nakayama, Chiba (JP)

(73) Assignee: OKI SEMICONDUCTOR CO., LTD., Tokyo (JP)

(21) Appl. No.: 12/944,773

(22) Filed: Nov. 12, 2010

(30) Foreign Application Priority Data
Dec. 21, 2009 (JP) 2009-288664

(51) Int. Cl. G09G 3/36; G09G 5/00

(52) U.S. Cl. 345/211; 345/87

(57) ABSTRACT

A source driver for a liquid crystal display panel which comprises a first amplifier which outputs a drive voltage to one of two mutually adjacent column terminals of the liquid crystal display panel, a second amplifier which outputs a drive voltage to the other of the two mutually adjacent column terminals of the liquid crystal display panel, a switching portion which alternately outputs a first reference voltage and a second reference voltage corresponding to image data to the first and second amplifiers through two output terminals by switching operations performed for each predetermined period, and a connecting portion which electrically connects lines from the two output terminals to the amplifiers, while the switching portion is performing a switching operation.

### BACKGROUND OF THE INVENTION

1. Field of the Invention

The present invention relates to a source driver for driving a liquid crystal display panel.

2. Description of the Related Art

It is known that liquid crystal display panels need to be alternately driven in order to prevent deterioration in properties of the liquid crystal material and thereby ensure the long-term reliability of the liquid crystal display panel. Accordingly, a conventional active matrix liquid crystal display device is operated in a manner such that a drive voltage, which depends on the gray scale level of image data, is applied by source drivers between the electrodes of a liquid crystal element in each cell (pixel) of the liquid crystal display panel. The drive voltage is then inverted with respect to a reference potential, for example, for each frame of image signals (see Japanese Patent Application Laid-Open No. 2001-34233). For example, an H drive voltage (higher potential) with respect to the reference potential may be applied in a frame, and an L drive voltage (lower potential) with respect to the reference potential may be applied in the next frame.

There is also available a dot inversion drive scheme by which all cells of a liquid crystal display panel are not simultaneously set to the same drive voltage with respect to a reference potential but mutually adjacent cells in each column and row are set to opposite drive voltages with respect to the reference potential. Also available is a two-line dot inversion scheme by which mutually adjacent cells in a column are set to opposite drive voltages and those in rows are set to an inverted voltage every two lines.

FIG. 1 illustrates an example of a signal waveform applied to one liquid crystal element of a liquid crystal display panel (not shown). A VCOM signal or a reference potential provides a potential or a constant DC voltage (for example, 6 V) to one of the two terminals of a liquid crystal element. Typically, the VCOM signal has a potential approximately one half of the output voltage from a drive source. As can be seen from the property shown with a solid line AL in FIG. 1, the drive voltage is inverted every one frame with respect to the VCOM signal. For the dot-inversion drive scheme, the property illustrated with a broken linen in FIG. 1 shows a drive voltage applied to adjacent liquid crystal elements. Note that the drive voltage is associated with the gray scale level of image data as described above; the inverted drive voltage, illustrated in FIG. 1, is constant (or has the same gray scale value).

FIG. 2 illustrates the configuration of a conventional source driver. The source driver includes a plurality of amplifiers 601, a plurality of first switching circuits 102, a plurality of second switching circuits 101, a plurality of first latches 606, a plurality of second latches 608, shift registers 607, a plurality of P—channel reference voltage selectors 602, a plurality of N-channel reference voltage selectors 603, an input pad and control circuit 701, a VH generator 501, a VL generator 502, and a plurality of delay circuits 521.

The conventional source driver of FIG. 2 has one drive section formed for six columns adjacent to each other in an active matrix liquid crystal display panel (not shown), FIG. 2 illustrating only two drive sections (a first drive section A1 and a second drive section A2). Furthermore, in six columns of each drive section, two adjacent columns form a drive group, so that in two signal supply lines associated with the two columns of each drive group, the first and second switching circuits 102 and 101 switch between data and reference voltages, as will be described later.

The shift register 607 of a plurality of flip-flops FT outputs latch signals L1, L2, . . . , indicative of the latch timing of data, to the first latches 606 in response to a starter signal.

The input pad and control circuit 701 receives image data, then rearranges it for the first latches 606 to sequentially acquire the image data at the output timing of the shift registers 607, and supplies six pieces of output image data 702 (R1, G1, B1, R2, G2, and B2) to the first latches 606.

As shown in FIG. 3, the image data 702 simultaneously includes six columns of data R1, G1, B1, R2, G2, and B2. That is, the first pieces of data R1, G1, B1, R2, G2, and B2 become the first six columns of data R_{—1, G}_1, B_1, R_2, G_2, and B_2. Then, the first pieces of data become the next six columns of data R_3, G_3, B_3, R_4, G_4, and B_4, and then the subsequent six columns of data R_5, G_5, B_5, R_6, G_6, and B_6.

For example, the image data 702 has 64 gray scales for 6-bit data, 256 gray scales for 8-bit data, or 1024 gray scales for 10-bit data.

The first latches 606 correspond in number to the column terminals of the liquid crystal display panel (103 to 108 in the first drive section A1), where each of the first latches 606 acquires any one piece of the image data 702 in response to an output timing signal of the shift register 607

The second latches 608 correspond in number to the column terminals of the liquid crystal display panel (109 to 114 in the first drive section A1), and latch and output the image data, acquired in the first latches 606, in response to a load signal LOAD. Note that the latches 103, 105, 107, 109, 111, and 113 form a first hold portion, while the latches 104, 106, 108, 110, 112, and 114 form a second hold portion.

The first switching circuits 102 serving as a first switching portion are half the column terminals in number (switching circuits 201 to 203 in the first drive section A1). Each of the switching circuits 102 switches the destination of a signal, latched as data in the two second latches 608 that form one drive group, in response to a polarity inversion signal POL between the inputs of the P-channel reference voltage selector 602 and the N-channel reference voltage selector 603. Although FIG. 2 illustrates each of the switching circuits 102 with two inputs and two outputs, each input and output have the number of input and output lines that corresponds to the number of data signal bits. The switching circuit for one bit is configured in the same manner as each of the switching circuits 101 of FIG. 4 as will be described later.

The VH generator 501 has a plurality of voltage divider circuits with a reference voltage VREF_H1 (12 V) applied to one end and a VREF_H2 (6 V) applied to the other end. Each of the plurality of voltage divider circuits divides the applied voltage and thereby generates a plurality of reference voltages VH that are mutually different from each other and correspond in number to the gray scales of image data.

The VL generator 502 has a plurality of voltage divider circuits with a reference voltage VREF_L1 (6 V) applied to one end and a VREF_L2 (0 V) applied to the other end. Each of the plurality of voltage divider circuits divides the applied voltage and thereby generates a plurality of reference voltages VL that are mutually different from each other and correspond in number to the gray scales of image data.

The P-channel reference voltage selectors 602 serving as a first selector portion are half the column terminals of the liquid crystal display panel in number and each made up of a P channel transistor. Each of the P—channel reference voltage selectors 602 selects any one of the plurality of reference voltages VH in accordance with data from the switching circuits 102 and outputs the resulting voltage to the switching circuits 101. The first drive section A1 has P-channel reference voltage selectors 115, 117, and 119.

The N-channel reference voltage selectors 603 serving as a second selector portion are half the column terminals of the liquid crystal display panel in number and each made up of a P channel transistor. Each of the N-channel reference voltage selectors 603 selects any one of the plurality of reference voltages VL in accordance with data from the switching circuits 102 and outputs the resulting voltage to the switching circuits 101. The first drive section A1 has N-channel reference voltage selectors 116, 118, and 120.

The second switching circuits 101 serving as a second switching portion are half the column terminals of the liquid crystal display panel in number (switching circuits 204, 205, and 206 in the first drive section A1). Each of the switching circuits 101 exchanges the respective connections between the inputs of the two amplifiers 601, which form one drive group, and the outputs of the P-channel and N-channel reference voltage selectors 602 and 603. The switching circuit 101 includes two switches that are switched over to each other by the polarity inversion signal POL as shown in FIG. 4. Each of the switching circuits 101 has two inputs and two outputs.

The amplifiers 601 include a plurality of amplifiers (for example, voltage followers) for employing the reference voltage, supplied from the switching circuits 101, as a drive voltage to drive the liquid crystal display panel, and correspond in number to the column terminals of the liquid crystal display panel.

The delay circuits 521 are disposed between the aforementioned drive sections to delay the load signal LOAD and supply the resulting signal to the second latches 608 of an adjacent drive section, thereby setting the timing at which to transfer image data to the second latches 608.

Note that the image data, the starter signal, the polarity inversion signal POL, and the load signal LOAD, as mentioned above, are generated at a timing controller (not shown) in accordance with an input image signal.

Suppose that in such a conventional source driver, the polarity inversion signal POL is first at L (low level), and the pieces of data R1, G1, B1, R2, G2, and B2 are R_1, G_1, B_1, R_2, G_2, and B_2, respectively. Now, a description will be made to a case where the drive voltage based on those pieces of data in the first drive section A1 is sequentially turned to an H side, L side, H side, L side, H side, and L side of the reference potential, respectively.

The latch signal L1 produced by the shift registers 607 causes the data R1 to be latched in the latch 103 of the first latches 606. Likewise, the G_1 is latched in the latch 104, the B_1 in the latch 105, the R 2 in the latch 106, the G2 in the latch 107, and the B 2 in the latch 108. Similarly, as for the R_1, G_1, B_1, R_2, G_2, and B_2 onward, a latch signal Gn (n=2 or (the number of outputs)/6) produced by the shift registers 607 allows the first latches 606 to sequentially latch the input image data 702.

All pieces of input image data associated with the number of outputs are latched in the first latches 606. Then, in response to the load signal LOAD, the data in the first latch 103 is transferred to the second latch 109, the data in the first latch 104 to the second latch 110, and the data in the first latch 105 to the second latch 111. Also simultaneously, the data in the first latch 106 is transferred to the second latch 112, the data in the first latch 107 to the second latch 113, and the data in the first latch 108 to the second latch 114. Likewise, the data in the first latches 606 subsequent to the first latch 108 is also collectively transferred to the second latches 608 sequentially every six columns in response to a signal Tn (n=2 or (the number of output)/6) that is obtained by delaying the load signal LOAD by six columns (every drive section).

The first switching circuit 201 allows the data in the second latch 109 to be entered into the P-channel reference voltage selector 115 of the P-channel reference voltage selectors 602, and the data in the second latch 110 to be entered into the N-channel reference voltage selector 116 of the N-channel reference voltage selectors 603. The switching circuit 202 allows the data in the second latch 111 to be entered into the P-channel reference voltage selector 117, and the data in the second latch 112 to be entered into the N-channel reference voltage selector 118. The switching circuit 203 allows the data in the second latch 113 to be entered into the P-channel reference voltage selector 119, and the data in the second latch 114 to be entered into the N-channel reference voltage selector 120. Furthermore, the P-channel reference voltage selectors 602 (115, 117, 119) are supplied from the VH generator 501 with a plurality of reference voltages VHm while the N-channel reference voltage selectors 603 (116, 118, 120) are supplied from the VL generator 502 with a plurality of reference voltages VL.

Each of the P-channel reference voltage selectors 115, 117, and 119 selects one reference voltage VH from among the plurality of reference voltages VH, which have a higher potential than the VCOM signal (a reference potential), in accordance with input image data.

Each of the N-channel reference voltage selectors 116, 118, and 120 selects one reference voltages VL from among the plurality of reference voltages VL, which have a lower potential than the VCOM signal (a reference potential), in accordance with input image data.

The reference voltage VH selectively supplied from the P-channel reference voltage selector 115 is allowed by the second switching circuit 204 to be applied to the amplifier 121 of the plurality of amplifiers 601, which produces an H-side drive voltage associated with the R_1. The reference voltage VL supplied from the N-channel reference voltage selector 116 is allowed by the second switching circuit 204 to be applied to the amplifier 122 of the amplifiers 601, which produces an L-side drive voltage associated with the G_1. The reference voltage VH supplied from the P-channel reference voltage selector 117 is allowed by the second switching circuit 205 to be applied to the amplifier 123 of the plurality of amplifiers 601, which produces an H-side drive voltage associated with the B_1. The reference voltage VL supplied from the N-channel reference voltage selector 118 is allowed by the switching circuit 205 to be applied to the amplifier 124 of the plurality of amplifiers 601, which produces an L-side drive voltage associated with the R_2. The reference voltage VH supplied from the P-channel reference voltage selector 119 is allowed by the second switching circuit 206 to be applied to the amplifier 125 of the plurality of amplifiers 601, which produces an H-side drive voltage associated with the G_2. The reference voltage VL supplied from the N-channel reference voltage selector 120 is allowed by the second switching circuit 206 to be applied to the amplifier 126 of the plurality of amplifiers 601, which produces an L-side drive voltage associated with the B_2.

Now, a description will be made to a case where the polarity inversion signal POL is switched over to H (high level). In this case, the drive voltage derived from the data R_1, G_1, B_1, R_2, G_2, B_2 in the first drive section A1 is turned sequentially to an L side, H side, L side, H side, L side, and H side of the reference potential, respectively.

Here, the operation from the input image data 702 to the second latches 608 is performed in the same manner as described above and thus will not be repeatedly explained. Each of the switching circuits 101 and 102 is switched over when POL=H.

The switching circuit 201 of the plurality of first switching circuits 102 allows the data in the second latch 109 to be entered into the N-channel reference voltage selector 116 of the N-channel reference voltage selectors 603. Likewise, the data in the second latch 110 is allowed to enter into the P-channel reference voltage selector 115 of the P-channel reference voltage selectors 602. The switching circuit 202 allows the data in the second latch 111 to be entered into the N-channel reference voltage selector 118, and the data in the second latch 112 to be entered into the P-channel reference voltage selector 117. The switching circuit 203 allows the data in the second latch 113 to be entered into the N-channel reference voltage selector 120, and the data in the second latch 114 to be entered into the P-channel reference voltage selector 119.

Each of the P-channel reference voltage selectors 115, 117, and 119 selects one reference voltages VH from among the plurality of reference voltages VH, which have a higher potential than the VCOM signal (a reference potential), in accordance with input image data.

Each of the N-channel reference voltage selectors 116, 118, and 120 selects one reference voltage VL from among the plurality of reference voltages VL, which have a lower potential than the VCOM signal (a reference potential), in accordance with input image data.

The reference voltage VH supplied from the P-channel reference voltage selector 115 is allowed by the switching circuit 204 to be applied to the amplifier 122 of the amplifiers 601, which produces an H-side drive voltage associated with the G_1. The reference voltage VL supplied from the N-channel reference voltage selector 116 is allowed by the switching circuit 204 to be applied to the amplifier 121 of the amplifiers 601, which produces an L-side drive voltage associated with the R_1. The reference voltage VH supplied from the P-channel reference voltage selector 117 is allowed by the switching circuit 205 to be applied to the amplifier 124 of the amplifiers 601, which produces an H-side drive voltage associated with the R_2. The reference voltage VL supplied from the N-channel reference voltage selector 118 is allowed by the switching circuit 205 to be applied to the amplifier 123 of the amplifiers 601, which produces an L-side drive voltage associated with the B_1. The reference voltage VH supplied from the P-channel reference voltage selector 119 is allowed by the switching circuit 206 to be applied to the amplifier 126 of the amplifiers 601, which produces an H-side drive voltage associated with the B_2. The reference voltage VL supplied from the N-channel reference voltage selector 120 is allowed by the switching circuit 206 to be applied to the amplifier 125 of the amplifiers 601, which produces an L-side drive voltage associated with the G_2.

However, there has been a problem with such conventional source drivers. That is, inverting the polarity inversion signal POL from L to H or from L to H causes variations in the reference voltages VH and VL applied from the second switching circuits 101 to the gate of each of the amplifiers 601. For example, as shown in FIGS. 5 and 6, suppose that when there is a change in polarity, a voltage of 9 V (POL=L) built by an application of the voltage VH in the gate capacity of the amplifier 121 is reduced by an application of the voltage VL to 3 V (POL=H). Also suppose that when there is a change in polarity, a voltage 3 V (POL=L) built by an application of the voltage VL in the gate capacity of the amplifier 122 associated with an adjacent column is raised to 9 V (POL=H) by an application of the voltage VH. In this case, the voltage VH is 9 V. However, as shown in FIG. 7, immediately after the polarity inversion signal POL is changed from L to H, the voltage of the VH supply line from the switch 101 charges the gate capacity of the amplifier 122, causing a level variation as an instant drop to near 3 V and rise back to 9 V. On the other hand, the voltage VL is 3 V. However, as shown in FIG. 8, immediately after the polarity inversion signal POL is changed from L to H, the voltage of the VL supply line from the switch 101 is to discharge the gate capacity of the amplifier 121, causing a level variation as an instant rise to near 9 V and back to 3 V. Accordingly, there is a delay in the drive voltage supplied from each of the amplifiers 121 and 122 to the liquid crystal display panel upon polarity inversion until the voltage reached the desired value associated with image data. This results in a drop in response speed of the source driver.

Recently, to improve the time-varying image property of the liquid crystal, driving at double speed has been predominantly employed, thus demanding high-speed responsivity of the source driver. Furthermore, increases in the number of columns and precision of the liquid crystal display panel have caused the resistance and capacitance from the amplifier inputs to VL and VH to increase. Thus, a level variation in VL and VH tends to delay the transition in the amplifier input voltage.

### SUMMARY OF THE INVENTION

It is therefore an object of the present invention to provide a source driver which can improve response speed upon polarity inversion of a drive voltage supplied to the column terminals of a liquid crystal display panel.

A source driver for a liquid crystal display panel according to the present invention comprising: a first hold portion which holds a piece data of image data associated with one of two mutually adjacent column terminals of a liquid crystal display panel; a second hold portion which holds a piece data of the image data associated with the other of the two mutually adjacent column terminals of the liquid crystal display panel; a first switching portion which has a first switch output terminal and a second switch output terminal, and alternately outputs the piece data held in the first hold portion and the piece data held in the second hold portion through the first switch output terminal and the second switch output terminal by switching operations performed for each predetermined period; a first reference voltage generator which produces a plurality of first reference voltages higher than a reference potential; a second reference voltage generator which produces a plurality of second reference voltages lower than the reference potential; a first selector portion which selects one first reference voltage from among the plurality of first reference voltages in accordance with output data from the first switch output terminal; a second selector portion which selects one second reference voltage from among the plurality of second reference voltages in accordance with output data from the second switch output terminal; a second switching portion which has a third switch output terminal and a fourth switch output terminal, and alternately outputs the first reference voltage selected by the first selector portion and the second reference voltage selected by the second selector portion through the third switch output terminal and the fourth switch output terminal by switching operations performed for each predetermined period; a first amplifier which inputs a voltage output from the third switch output terminal and outputs a drive voltage to one of the two mutually adjacent column terminals of the liquid crystal display panel; a second amplifier which inputs a voltage output from the fourth switch output terminal and outputs a drive voltage to the other of the two mutually adjacent column terminals of the liquid crystal display panel; and a connecting portion which electrically connects a voltage input line from the third switch output terminal of the first amplifier to a voltage input line from the fourth switch output terminal of the second amplifier, while the second switching portion is performing a switching operation.

The source driver for a liquid crystal display panel according to the present invention is provided with the connecting portion which electrically connects the voltage input line from the third switch output terminal of the first amplifier with the voltage input line from the fourth switch output terminal of the second amplifier while a switching operation is being performed by the second switching portion, i.e., polarity is being inverted. This allows the voltage of each input line of the first amplifier and the second amplifier to be maintained generally at the average voltage level of each immediately preceding input voltage level while a switching operation is being performed for polarity inversion. Therefore, since there will be no such a large voltage level variation as used to occur before, the voltage of each input line of the first amplifier and the second amplifier can immediately reach the desired voltage associated with data even after polarity inversion. As a result, it is possible to provide improved response speed when polarity is being inverted.

### BRIEF DESCRIPTION OF THE DRAWINGS

FIG. 1 is a view illustrating an example of a signal waveform applied to one liquid crystal element of a liquid crystal display panel;

FIG. 2 is a block diagram illustrating the configuration of a conventional source driver;

FIG. 3 is a view illustrating the data structure of image data in FIG. 2;

FIG. 4 is a view illustrating the configuration of a second switching circuit in the source driver of FIG. 2;

FIG. 5 is an explanatory view illustrating the operation of the source driver when POL=L;

FIG. 6 is an explanatory view illustrating the operation of the source driver when POL=H;

FIG. 7 is a view illustrating a variation in voltage of a VH supply line upon polarity inversion;

FIG. 8 is a view illustrating a variation in voltage of a VL supply line upon polarity inversion;

FIG. 9 is a block diagram illustrating the configuration of a source driver according to an embodiment of the present invention;

FIG. 10 is an explanatory view illustrating the operation of the source driver of FIG. 9 when POL=L;

FIG. 11 is an explanatory view illustrating the operation of the source driver of FIG. 9 when a second switch is OFF;

FIG. 12 is an explanatory view illustrating the operation of the source driver of FIG. 9 when POL=H;

FIG. 13 is a view illustrating a variation in voltage of a VH supply line upon polarity inversion of the source driver of FIG. 9;

FIG. 14 is a view illustrating a variation in voltage of a VL supply line upon polarity inversion of the source driver of FIG. 9;

FIG. 15 is a block diagram illustrating the configuration of a source driver according to another embodiment of the present invention;

FIG. 16 is an explanatory view illustrating the operation of the source driver of FIG. 15 when POL=L;

FIG. 17 is an explanatory view illustrating the operation of the source driver of FIG. 15 when a second switch is OFF;

FIG. 18 is an explanatory view illustrating the operation of the source driver of FIG. 15 when POL=H;

FIG. 19 is a view illustrating a variation in voltage of a VH supply line upon polarity inversion of the source driver of FIG. 15; and

FIG. 20 is a view illustrating a variation in voltage of a VL supply line upon polarity inversion of the source driver of FIG. 15.

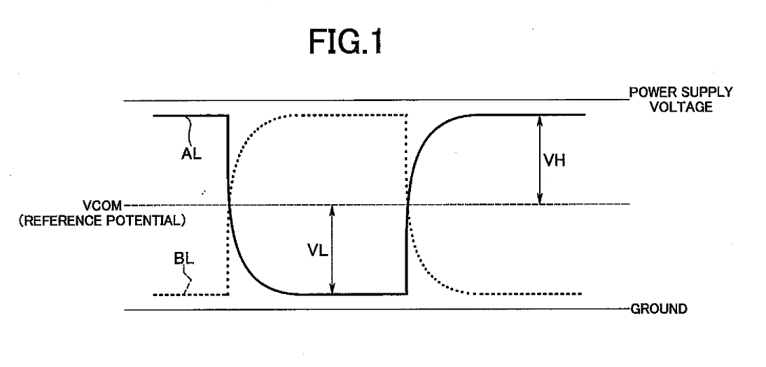

### DETAILED DESCRIPTION OF THE INVENTION

Now, the present invention will be described below in more detail with reference to the accompanying drawings in accordance with the embodiments.

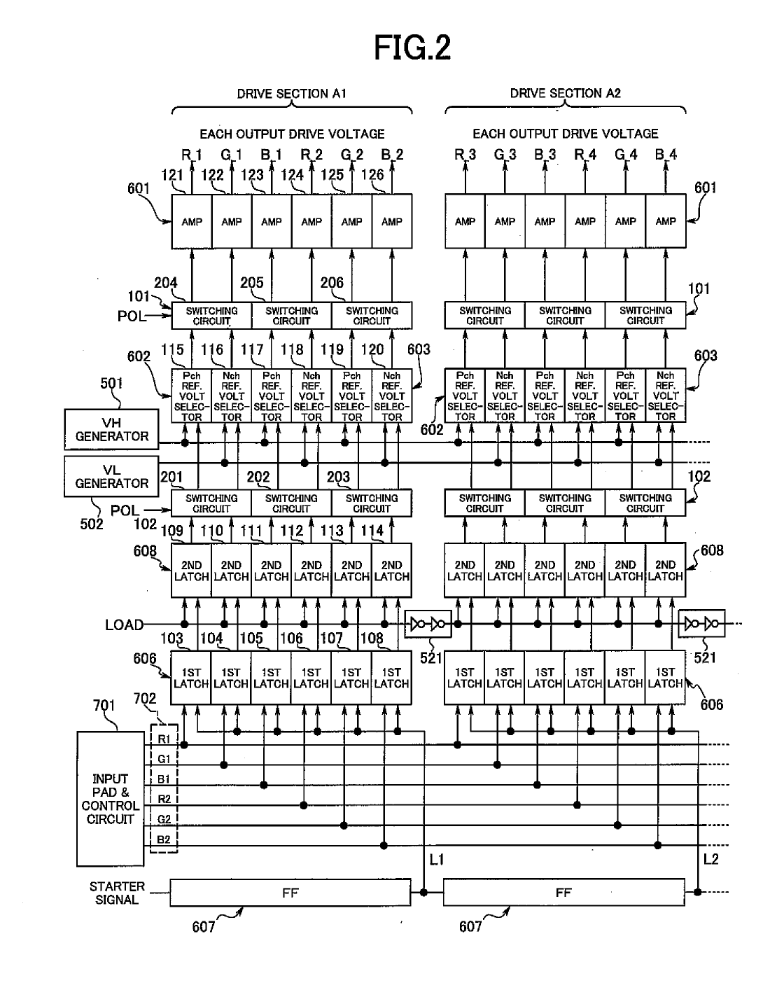

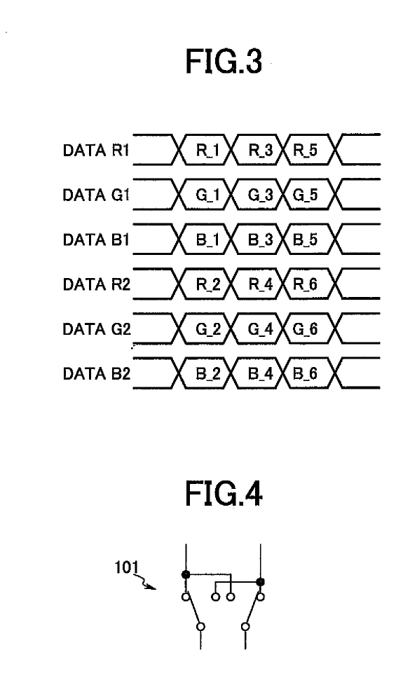

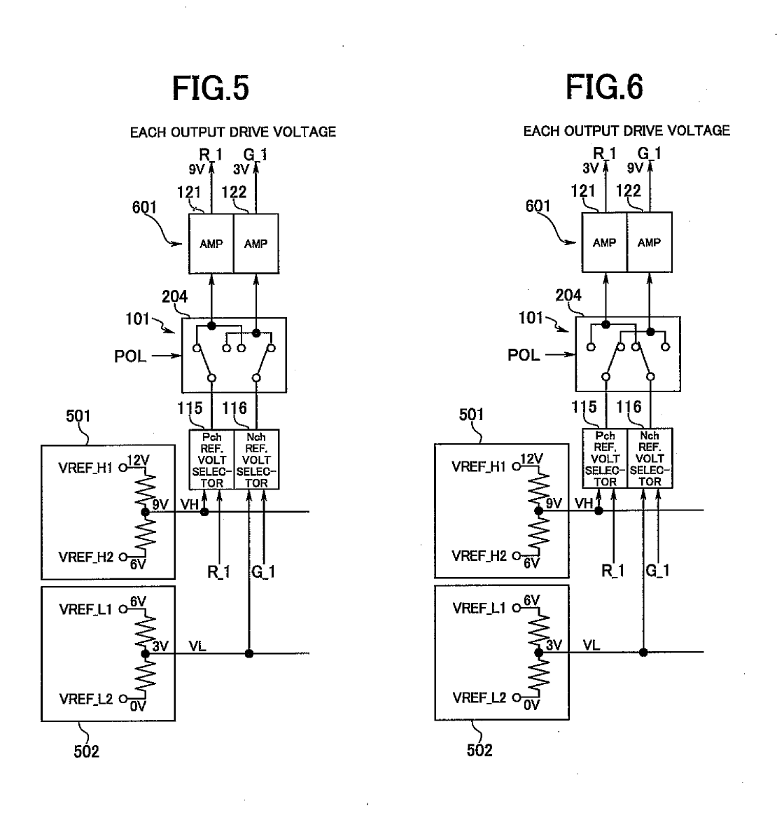

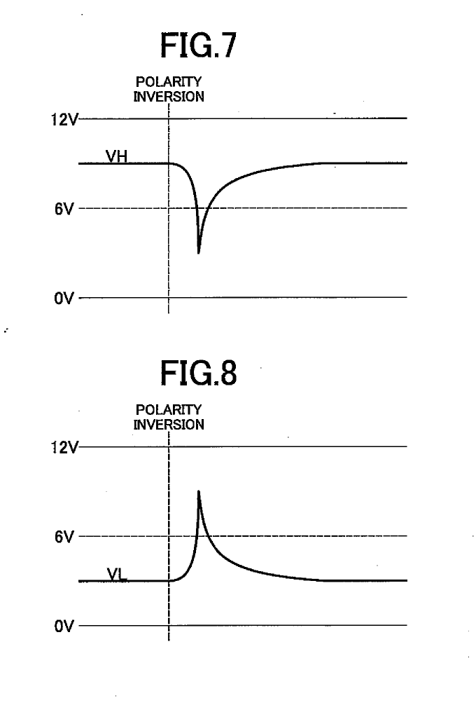

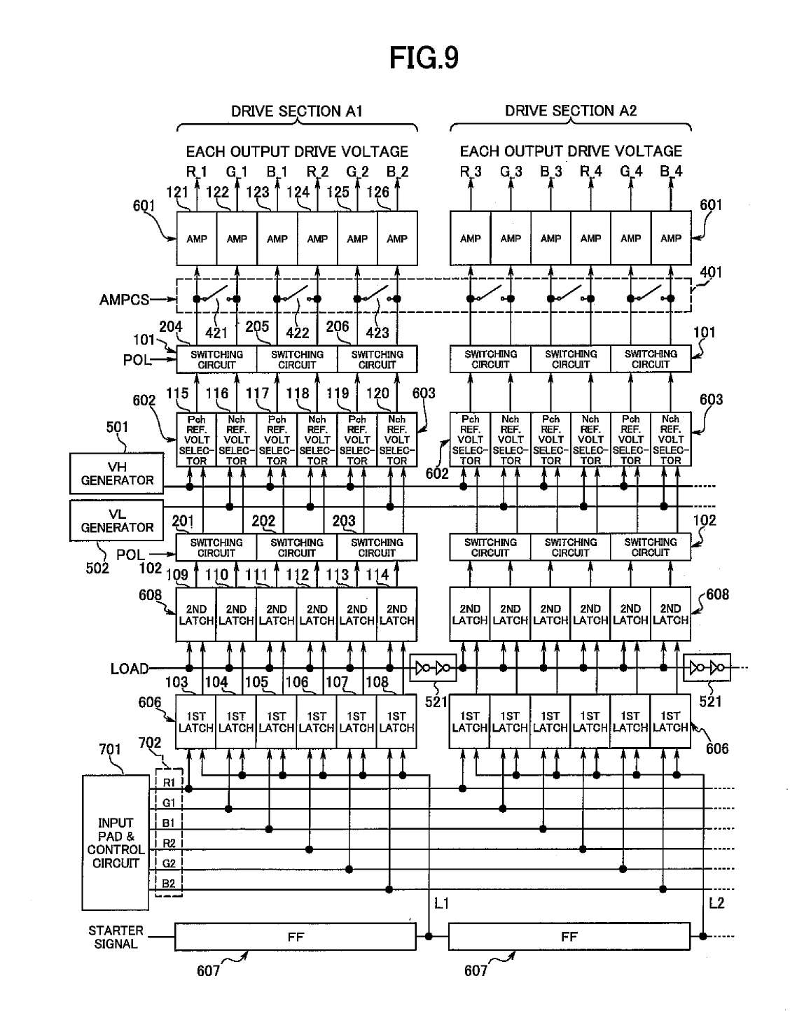

FIG. 9 illustrates the configuration of a source driver according to an embodiment of the present invention. The source driver of FIG. 9 is illustrated with the same symbols as those of the source driver of FIG. 2 for the same components, with a plurality of switches 401 (corresponding to the connecting portion) disposed between the switching circuits 101 and the amplifiers 601. FIG. 9 shows only those switches 401 that are used for the first drive section A1 and the second drive section A2. In particular, the switches 401 of the first drive section are designated with symbols 421 to 423. Each of the switches 401 is an on-off type switch. In the first drive section A1, the switch 421 is disposed between the input line of the amplifier 121 and the input line of the amplifier 122. Likewise, the switch 422 is disposed between the input line of the amplifier 123 and the input line of the amplifier 124, and the switch 423 is disposed between the input line of the amplifier 125 and the input line of the amplifier 126. The switches 401 of other drive sections are also disposed in the same manner.

Each of these switches 401 is normally in an OFF state, but is turned ON in response to a signal AMPCS supplied from a timing controller described in relation to the source driver of FIG. 2. The source driver of FIG. 9 operates in the same manner as the conventional device of FIG. 2 from the stage of input image data to the switch 102, and thus the description of this operation will be omitted.

Note that the output terminal of each of the first switching circuits 102 on the side of the P-channel reference voltage selector 602 is a first switch output terminal, while the output terminal on the side of the N-channel reference voltage selector 603 is a second switch output terminal. Two output terminals of each of the second switching circuits 101 on the side of the amplifier 601 are a third switch output terminal and a fourth switch output terminal.

Furthermore, suppose that when the polarity inversion signal POL switches from L to H or from H to L, each of the switching circuits 101 may be temporarily in an OFF state, connecting to nowhere, in accordance with the polarity inversion signal POL. In this case, during the OFF period while each of the switching circuits 101 is being switched, each of the switches 401 is turned ON.

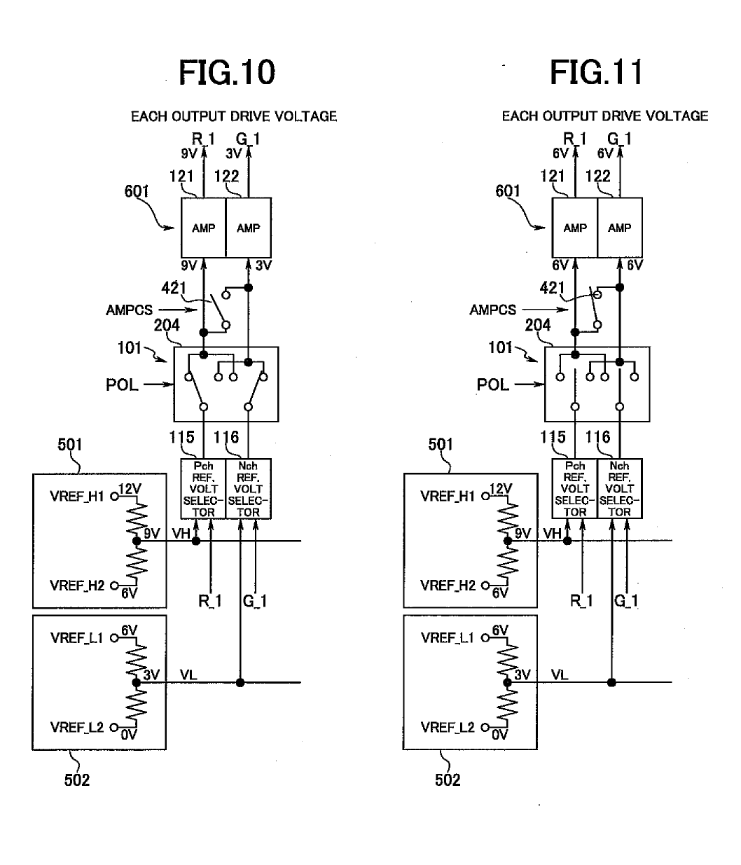

Now, referring to FIGS. 10 to 12, a description will be made to the operation of the selectors 115 and 116 onward in relation to the data R_1 and G_1 of the first drive section A1.

First, as shown in FIG. 10, when POL=L, the 9 V reference voltage VH of the plurality of reference voltages VH from the VH generator 501 is selected by the P-channel reference voltage selector 115 in response to the output data R_1 from the switching circuit 201. With the reference voltage VH (9 V) supplied to the input of the amplifier 121 via the switching circuit 205, the output drive voltage of the amplifier 121 is 9 V corresponding to the R_1. In accordance with the output data G_1 of the switching circuit 201, the 3 V reference voltage VL of the plurality of reference voltages VL from the VL generator 502 is selected by the N-channel reference voltage selector 116. With the reference voltage VL (3 V) supplied to the input of the amplifier 122 via the switching circuit 205, the output drive voltage of the amplifier 122 is 3 V corresponding to the G_1. At this time, the switch 401 (the switch 421 of FIG. 10) is in an OFF state.

Then, until the polarity inversion signal POL is changed from L to H, as shown in FIG. 11, the second switching circuit 205 is being switched and in an OFF state, connecting to nowhere. On the other hand, the switch 421 is immediately turned ON in response to the signal AMPCS. The switch 421 having been turned ON causes the switch 421 to connect electrically between the inputs of the amplifiers 121 and 122. This allows a voltage of 9 V built in the gate capacity of the amplifier 121 and a voltage of 3 V built in the gate capacity of the amplifier 122 to be averaged, resulting in the input voltage of each of the amplifiers 121 and 122 being 6 V.

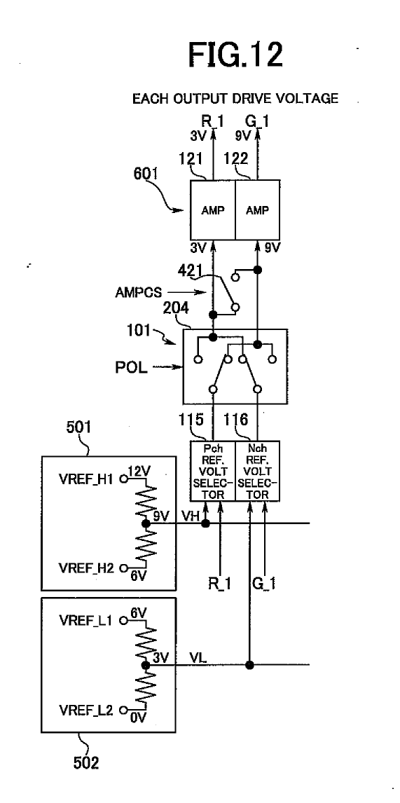

Immediately after that, when the polarity inversion signal POL is changed to H, as shown in FIG. 12, the switching circuit 205 is changed from an OFF state. In response to the signal AMPCS, the switch 421 is turned OFF. For example, as shown in FIG. 12, in accordance with the output data G_1 of the switching circuit 201, the 9 V reference voltage VH of the plurality of reference voltages VH from the VH generator 501 is selected by the P-channel reference voltage selector 115. Since the reference voltage VH (9 V) is supplied to the input of the amplifier 122 via the switching circuit 205, the output drive voltage of the amplifier 122 is 9 V corresponding to the G_1. In accordance with the output data R_1 of the switching circuit 201, the 3 V reference voltage VL of the plurality of reference voltages VL from the VL generator 502 is selected by the N-channel reference voltage selector 116. Since the reference voltage VL (3 V) is supplied to the input of the amplifier 121 via the switching circuit 205, the output drive voltage of the amplifier 121 is 3 V corresponding to the R_1.

This operation holds true for the other pieces of data than the data R_1 and G_1 and the other drive sections of the first drive section A1.

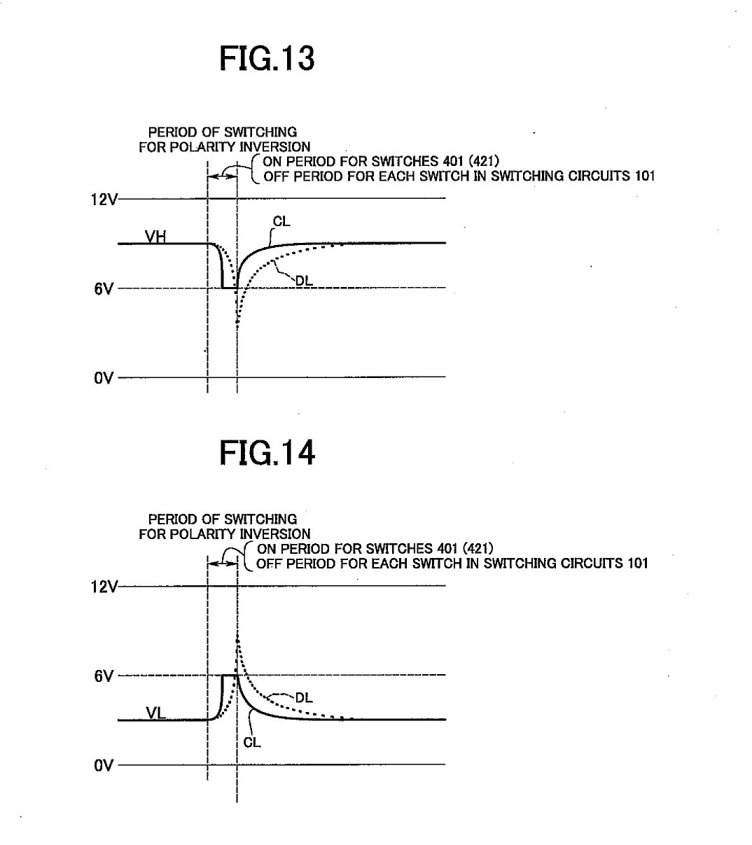

FIG. 13 illustrates changes in voltage (the solid line CL of FIG. 13) of the VH supply line from the switching circuit 101 (the switching circuit 205) to the amplifier 121 or 122 during the operation period of FIGS. 10 to 12. During an OFF period while the switching circuit 205 is being switched, the switch 421 is turned ON allowing the inputs of the amplifiers 121 and 122 to connect electrically to each other. This causes the voltage of the VH supply line to change from 9 V to 6 V as described above but never drop below that. Therefore, immediately after the switching circuit 205 has been switched over, the voltage of the VH supply line returns to 9 V more quickly than before (the property shown by the broken line DL of FIG. 13).

FIG. 14 illustrates changes in voltage (the solid line CL of FIG. 14) of the VL supply line from the switching circuit 101 (the switching circuit 205) to the amplifier 121 or 122 during the operation period of FIGS. 10 to 12. During an OFF period while the switching circuit 205 is being switched, the switch 421 is turned ON allowing the inputs of the amplifiers 121 and 122 to connect electrically to each other. This causes the voltage of the VL supply line to change from 3 V to 6 V as described above but never rise above that. Therefore, immediately after the switching circuit 205 has been switched over, the voltage of the VL supply line returns to 3 V more quickly than before (the property shown by the broken line DL of FIG. 14).

As such, when the polarity inversion signal POL is switched from L to H or from H to L, a transition of the input voltage to the amplifiers 601 is effected more quickly than for the conventional device. It is thus possible to change swiftly the output drive voltage from the amplifiers 601 to the liquid crystal display panel to the desired voltage associated with image data. Thus, the response speed of the source driver can be improved. As a result, it is possible to improve the moving picture display performance of the liquid crystal display panel.

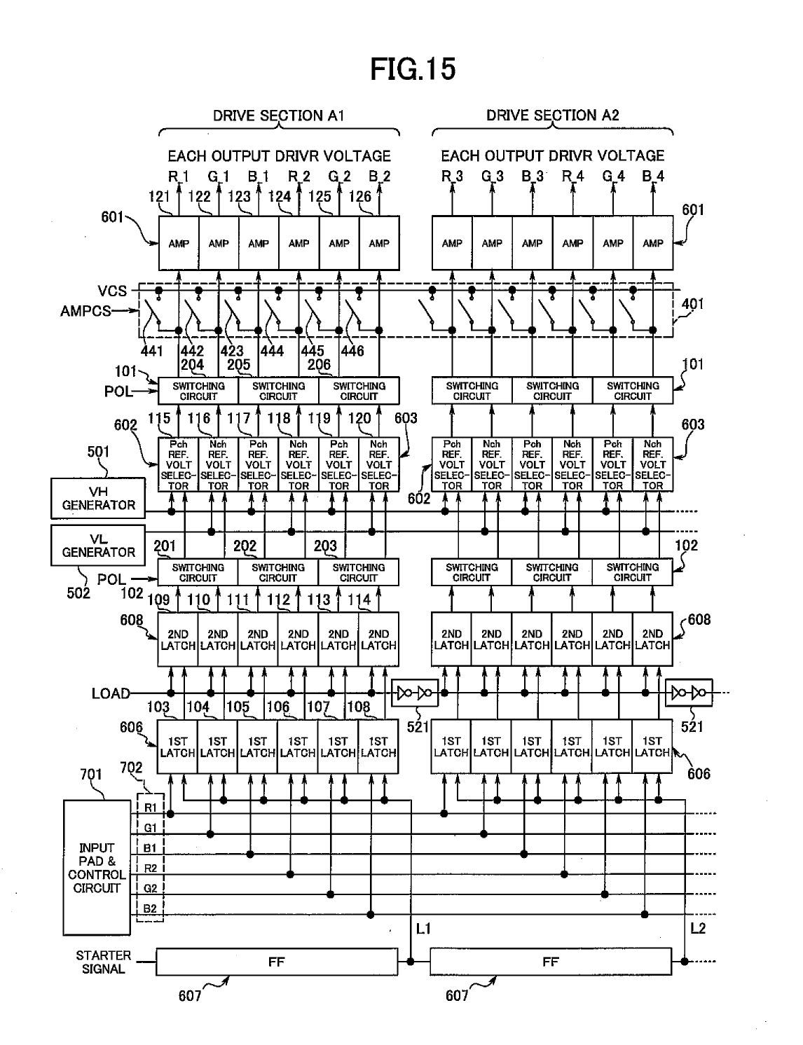

FIG. 15 illustrates the configuration of the source driver according to another embodiment of the present invention. The source driver of FIG. 15 is illustrated with the same symbols as those of the source driver of FIG. 2 for the same components, with a plurality of on-off switches 401 disposed between the input line of each of the amplifiers 601 and a common line VCS. FIG. 15 shows only those switches 401 that are used for the first drive section A1 and the second drive section A2. In particular, the switches 401 of the first drive section A1 are designated with symbols 441 to 446. The common line VCS is in a floating state, connecting to nowhere, when all the switches 401 are in an OFF state.

Each of the switches 401 is normally in an OFF state, but is turned ON in response to the signal AMPCS supplied from the timing controller described in relation to the source driver of FIG. 2.

The source driver of FIG. 15 operates in the same manner as the conventional device of FIG. 2 from the stage of input image data to the switch 102, and thus the description of this operation will be omitted.

Note that suppose that when the polarity inversion signal POL switches from L to H or from H to L, each of the switching circuits 101 may be temporarily in an OFF state, connecting to nowhere, in accordance with the polarity inversion signal POL. In this case, during the OFF period while each of the switching circuits 101 is being switched, each of the switches 401 is turned ON.

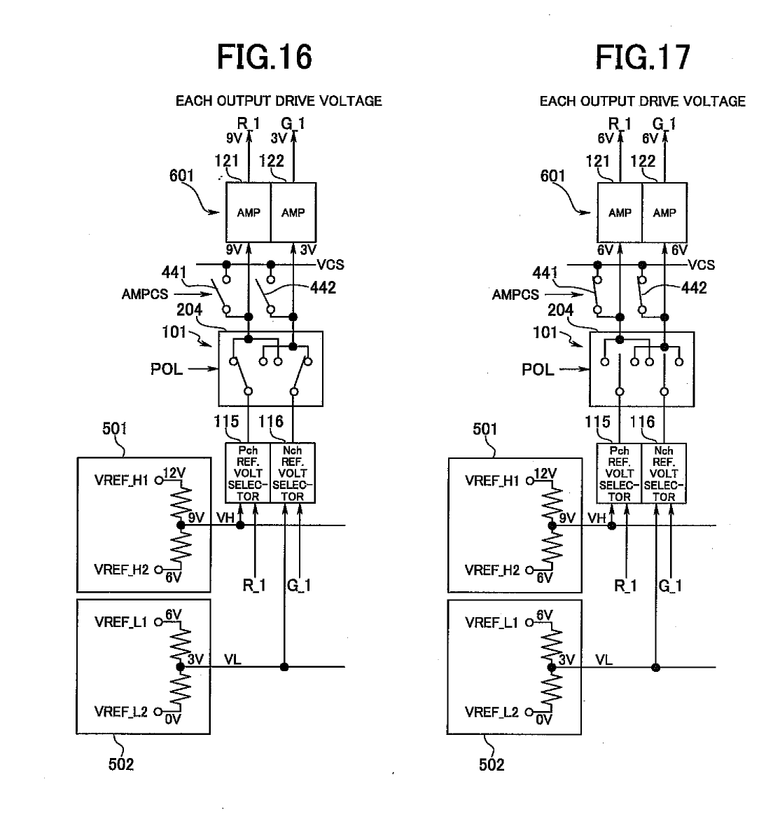

Now, referring to FIGS. 16 to 18, a description will be made to the operation of the selectors 115 and 116 onward in relation to the data R_1 and G_1 of the first drive section A1.

First, as shown in FIG. 16, when POL=L, the 9 V reference voltage VH of the plurality of reference voltages VH from the VH generator 501 is selected by the P—channel reference voltage selector 115 in accordance with the output data R_1 of the switching circuit 201. With the reference voltage VH (9V) supplied to the input of the amplifier 121 via the switching circuit 205, the output drive voltage of the amplifier 121 is 9 V corresponding to the R_1. In accordance with the output data G_1 of the switching circuit 201, the 3 V reference voltage VL of the plurality of reference voltages VL from the VL generator 502 is selected by the N-channel reference voltage selector 116. With the reference voltage VL (3 V) supplied to the input of the amplifier 122 via the switching circuit 205, the output drive voltage of the amplifier 122 is 3 V corresponding to the G1. At this time, the switches 401 (switches 441 and 442 of FIG. 16) are in an OFF state, with the common line VCS in a floating state.

Then, until the polarity inversion signal POL is changed from L to H, as shown in FIG. 17, the second switching circuit 205 is being switched and in an OFF state, connecting to nowhere. On the other hand, the switches 401, i.e., the switches 441 and 442 are turned ON in response to the signal AMPCS. The switches 441 and 442 having been turned ON causes the inputs of the amplifiers 121 and 122 to electrically connect to each other via the switches 441 and 442 and the common line VCS. This allows a voltage of 9 V built in the gate capacity of the amplifier 121 and a voltage of 3 V built in the gate capacity of the amplifier 122 to be averaged, resulting in the input voltage of each of the amplifiers 121 and 122 being 6 V.

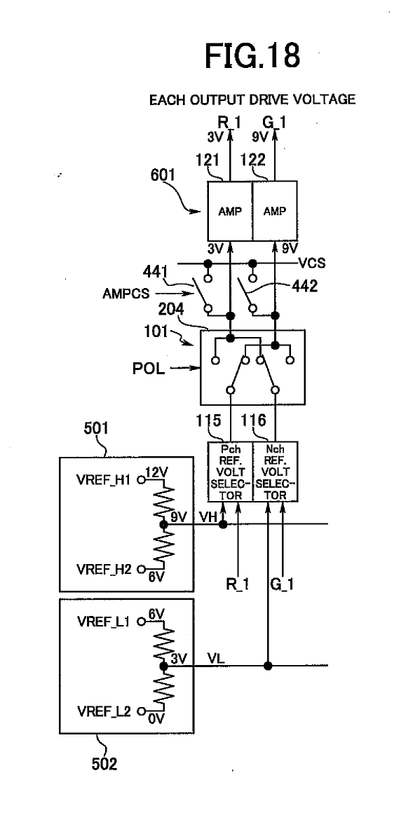

Immediately after that, when the polarity inversion signal POL is changed to H, as shown in FIG. 18, the switching circuit 205 is changed from an OFF state. In response to the signal AMPCS, the switches 441 and 442 are turned OFF, with the common line VCS in a floating state. For example, as shown in FIG. 18, in accordance with the output data G_1 of the switching circuit 201, the 9 V reference voltage VH of the plurality of reference voltages VH from the VH generator 501 is selected by the P-channel reference voltage selector 115. Since the reference voltage VH (9 V) is supplied to the input of the amplifier 122 via the switching circuit 205, the output drive voltage of the amplifier 122 is 9 V corresponding to the G_1. In accordance with the output data R_1 of the switching circuit 201, the 3 V reference voltage VL of the plurality of reference voltages VL from the VL generator 502 is selected by the N-channel reference voltage selector 116. Since the reference voltage VL (3 V) is supplied to the input of the amplifier 121 via the switching circuit 205, the output drive voltage of the amplifier 121 is 3 V corresponding to the R_1.

This operation holds true for the other pieces of data than the data R1 and G1 and the other drive sections of the first drive section A1.

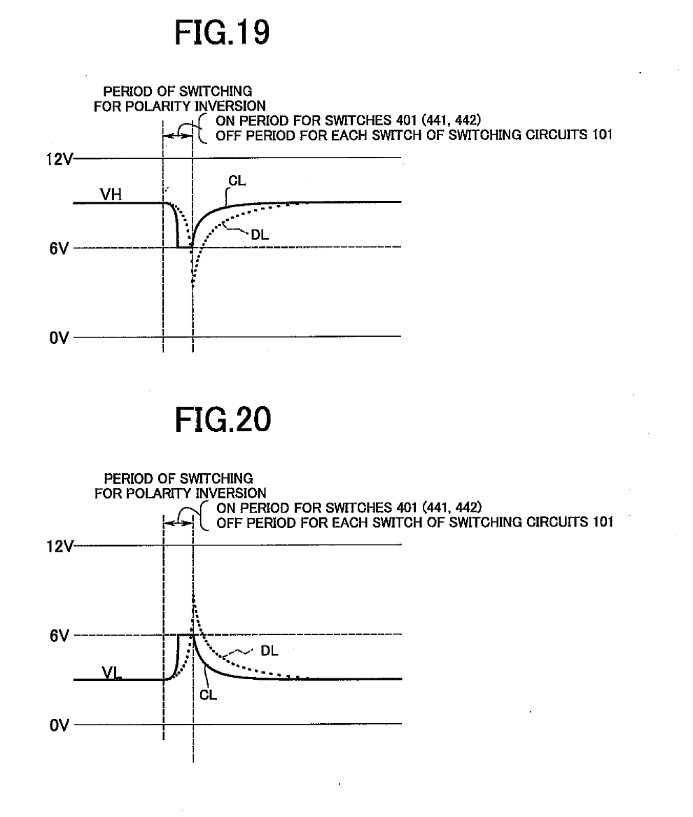

FIG. 19 illustrates changes in voltage (the solid line CL of FIG. 19) of the VH supply line from the switching circuit 205 to the amplifier 121 or 122 during the operation period of FIGS. 16 to 18. During an OFF period while the switching circuit 205 is being switched, the switches 441 and 442 are turned ON allowing the inputs of the amplifiers 121 and 122 to connect electrically to each other. This causes the voltage of the VH supply line to change from 9 V to 6 V as described above but never drop below that. Therefore, immediately after the switching circuit 205 has been switched over, the voltage of the VH supply line returns to 9 V more quickly than before (the property shown by the broken line DL of FIG. 19).

FIG. 20 illustrates changes in voltage (the solid line CL of FIG. 20) of the VL supply line from the switching circuit 205 to the amplifier 121 or 122 during the operation period of FIGS. 16 to 18. During an OFF period while the switching circuit 205 is being switched, the switches 441 and 442 are turned on allowing the inputs of the amplifiers 121 and 122 to connect electrically to each other. This causes the voltage of the VL supply line to change from 3 V to 6 V as described above but never rise above that. Therefore, immediately after the switching circuit 205 has been switched over, the voltage of the VL supply line returns to 3 V more quickly than before (the property shown by the broken line DL of FIG. 19).

As such, when the polarity inversion signal POL is switched from L to H or from H to L, a transition of the input voltage to the amplifiers 601 is effected more quickly than for the conventional device. It is thus possible to improve display responsivity. Furthermore, the same input voltage for all the amplifiers 601 reduces variations in the input voltage transition of the amplifiers 601 between columns when the polarity inversion signal POL is switched from L to H or from H to L, thereby decreasing variations in the output voltage transition of the amplifiers 601 between columns.

In each of the aforementioned embodiments, a voltage of 9V is selected from among the plurality of reference voltages VH by the P-channel reference voltage selector, while a voltage of 3 V is selected from among the plurality of reference voltages VL by the N-channel reference voltage selector. However, the same effect can be obtained even if a voltage VH other than 9 V is selected from among the plurality of reference voltages VH and a voltage VL other than 3 V is selected from among the plurality of reference voltages VL. Furthermore, the present invention can also be applicable to a case where the supply reference voltages VH and VL to the amplifiers 601 are the same but vary before and after the polarity inversion signal POL is switched over. Furthermore, the reference voltages VREF_H1 and VREF_H2 that are used to produce the plurality of reference voltages VH in the VH generator 501 are not limited to 12 V and 6 V, which have been shown by way of example; other voltage values are also acceptable. Likewise, the reference voltages VREF_L1 and the VREF_L2 that are used to produce the plurality of reference voltages VL in the VL generator 502 are not limited to 6 V and 0 V, which have been shown by way of example; other voltage values are also acceptable.

The source driver of the present invention can be implemented as a semiconductor integrated circuit.

This application is based on Japanese Application No. 2009-288664, which is incorporated herein by reference.

What is claimed is:

1. A source driver for a liquid crystal display panel, comprising:
a first hold portion which holds a piece data of image data associated with one of two mutually adjacent column terminals of the liquid crystal display panel;
a second hold portion which holds a piece data of the image data associated with the other of the two mutually adjacent column terminals of the liquid crystal display panel;
a first switching portion which has a first switch output terminal and a second switch output terminal, and alternately outputs the piece data held in the first hold portion and the piece data held in the second hold portion through the first switch output terminal and the second switch output terminal by switching operations performed for each predetermined period;
a first reference voltage generator which produces a plurality of first reference voltages higher than a reference potential;
a second reference voltage generator which produces a plurality of second reference voltages lower than the reference potential;
a first selector portion which selects one first reference voltage from among the plurality of first reference voltages in accordance with output data from the first switch output terminal;
a second selector portion which selects one second reference voltage from among the plurality of second reference voltages in accordance with output data from the second switch output terminal;
a second switching portion which has a third switch output terminal and a fourth switch output terminal, and alternately outputs the first reference voltage selected by the first selector portion and the second reference voltage selected by the second selector portion through the third switch output terminal and the fourth switch output terminal by switching operations performed for each predetermined period;
a first amplifier which inputs a voltage output from the third switch output terminal and outputs a drive voltage to one of the two mutually adjacent column terminals of the liquid crystal display panel;
a second amplifier which inputs a voltage output from the fourth switch output terminal and outputs a drive voltage to the other of the two mutually adjacent column terminals of the liquid crystal display panel; and
a connecting portion which electrically connects a voltage input line from the third switch output terminal of the first amplifier to a voltage input line from the fourth switch output terminal of the second amplifier, while the second switching portion is performing a switching operation.

2. The source driver according to claim 1, wherein
assuming that the first hold portion, the second hold portion, the first switching portion, the first selector portion, the second selector portion, the second switching portion, the first amplifier, and the second amplifier constitute a drive group, a number of drive groups is half a number of column terminals of the liquid crystal display panel, and
for each of the drive groups, while the second switching portion is performing the switching operation, the connecting portion electrically connects the voltage input line from the third switch output terminal of the first amplifier to the voltage input line from the fourth switch output terminal of the second amplifier.

3. The source driver according to claim 2, wherein the connecting portion is an on-off switch provided between the voltage input line from the third switch output terminal of the first amplifier and the voltage input line from the fourth switch output terminal of the second amplifier, the on-off switch being in an ON state while the second switching portion is performing the switching operation and being an OFF state while the second switching portion is not performing the switching operation.

4. The source driver according to claim 2, wherein the second switching portion is in an OFF state while the switching operation is beingperformed.

5. The source driver according to claim 1, wherein
assuming that the first hold portion, the second hold portion, the first switching portion, the first selector portion, the second selector portion, the second switching portion, the first amplifier, and the second amplifier constitute a drive group, a number of drive groups is half a number of column terminals of the liquid crystal display panel, and
for each of the drive groups, while the second switching portion is performing the switching operation, the connecting portion electrically connects the voltage input line from the third switch output terminal of the first amplifier to the voltage input line from the fourth switch output terminal of the second amplifier via a common line for all the drive groups.

6. The source driver according to claim 2, wherein the connecting portion includes a first on-off switch provided between the voltage input line from the third switch output terminal of the first amplifier and the common line, and a second on-off switch provided between the voltage input line from the fourth switch output terminal of the second amplifier and the common line, the first and second on-off switches being in an ON state while the second switching portion is performing the switching operation and being an OFF state while the second switching portion is not performing the switching operation.

7. The source driver according to claim 5, wherein the second switching portion is in an OFF state while the switching operation is beingperformed.

8. The source driver according to claim 1, wherein the predetermined period is equivalent to one frame period of the image data.
